(19) United States
(12) Patent Application Publication
(10) Pub. No.: US 2009/0211210 A1
(43) Pub. Date: Aug. 27, 2009

(54) Trap Device

(76) Inventors: David Engerran, West Sussex (GB); Philip Dixon, West Yorkshire (GB); Mark Christopher Hope, Surrey (GB)

Correspondence Address: Edwards Vacuum, Inc., 2041 MISSION COLLEGE BOULEVARD, SUITE 260, SANTA CLARA, CA, 95054, US

(21) Appl. No.: 11/885,721

(22) PCT Filed: Feb. 10, 2006
(86) PCT No.: PCT/GB06/00468

§ 371 Date: May 20, 2008

(30) Foreign Application Priority Data
Mar. 2, 2005 (GB) 0504312.0

(51) Int. Cl. B01D 46/42

(52) U.S. Cl. 55/344

(57) ABSTRACT

A trap device (18) is described for removing species from a gas stream drawn from an enclosure by a vacuum pump. The trap comprises a casing (28) having an inlet (16) connectable to the enclosure for receiving the gas stream therefrom and an outlet (20) connectable to the vacuum pump for exhausting the gas stream from the casing. A plurality of cartridges are each removably insertable into the casing through a respective aperture (36) of the casing (28) and provide a respective flow passage between an inlet and an outlet thereof for gas passing through the casing, each cartridge housing means for removing species from the gas passing therethrough as solid material collecting within the cartridge.

The present invention relates to a trap device, and in particular to a trap device for removing species from a gas stream drawn from an enclosure by a vacuum pump.

During semiconductor processes such as chemical vapour deposition processing, deposition gases are supplied to a process chamber to form a deposition layer on the surface of a substrate. As the residence time in the chamber of the deposition gas is relatively short, only a small proportion of the gas supplied to the chamber is consumed during the deposition process. Consequently, unconsumed gas molecules pumped from the chamber by a vacuum pump can pass through the pump in a highly reactive state.

Many semiconductor processes use or generate solid, condensable or subliming compounds. For example, low-pressure chemical vapour deposition silicon nitride (LPCVD nitride) processes tend to use chlorosilanes (such as dichlorosilane or trichlorosilane) and ammonia to produce a uniform layer of silicon nitride to insulate a substrate. These processes, tend to produce a very thick film of silicon nitride, and consequently require very long deposition cycles, typically 3 to 8 hours. By-products of this process include complex ammonium-chloro-silicate salts, for example, ammonium hexachlorosilicate, which sublimes at 120° C. at atmospheric pressure.

If the unconsumed process gas or by-product is condensable, sublimation on lower temperature surfaces can result in the accumulation of powder or dust within the vacuum pump, which can effectively fill the vacant running clearance between the rotor and stator elements of the pump, leading to a loss of pumping performance and ultimately pump failure.

In view of this, a cold trap device is typically provided at the outlet of a pump heated to a temperature above which the condensable species will pass through the pump without condensing within the pump. Such traps typically comprise a water-cooled coil located within a flow passage of the trap. As the gas stream flows through the flow passage, it contacts the coil, which cools the gas stream and causes low boiling point species within the gas stream to condense inside the trap.

A problem associated with the use of such a trap is that particulate condensate can accumulate within the flow passage and on the coil after only a relatively short period of time. If this build-up of solids is allowed to continue uninterrupted, the trap can become completely blocked. As a result, the trap must be periodically serviced to remove the condensate from within the trap, incurring down time and loss of production. Furthermore, the person cleaning the trap becomes exposed to the condensate, which, depending on the chemistry of the condensate may be particularly hazardous.

In addition, by heating the pump, the temperature of the gas stream may be heated to a temperature above which unreacted species within the gas stream are converted into solid material. For example, tungsten hexafluoride passing through a hot pump can form deposits of tungsten within the pump, which can lead to damage of the pumping mechanism.

It is an aim of at least the preferred embodiments of the invention to provide a trap device connectable to the inlet of a vacuum pump and which can enable rapid and safe servicing thereof.

In a first aspect, the present invention provides a trap device for removing species from a gas stream drawn from an enclosure by a vacuum pump, the device comprising a casing having an inlet for receiving the gas stream and an outlet for exhausting the gas stream from the casing, and a plurality of cartridges each being removably insertable into the casing through a respective aperture of the casing to provide a plurality of flow passages for gas passing through the casing, each flow passage extending between an inlet and an outlet of a respective cartridge, each cartridge housing means for removing species from the gas passing therethrough as solid material collecting within the cartridge.

By providing a plurality of cartridges that can be readily removed from the casing of the trap for cleaning, the speed and ease at which the trap is periodically serviced can be markedly improved. For example, when one of the cartridges requires cleaning, that cartridge can be readily removed from the trap and replaced by a fresh cartridge. The replaced cartridge can then be taken to a suitable place for cleaning. In addition, as particulates are retained within the cartridge, the level of user exposure to the condensate during servicing is minimised. Furthermore, due to the use of a plurality of removal means, each within a respective cartridge, the surface area of the removal means can be maximised.

In preferred embodiments, each cartridge comprises means for condensing species from the gas passing therethrough as a condensate collecting within the cartridge. Thus, in a second aspect the present invention provides a trap device for removing condensable species from a gas stream drawn from an enclosure by a vacuum pump, the device comprising a casing having an inlet for receiving the gas stream and an outlet for exhausting the gas stream from the casing, and a plurality of cartridges each being removably insertable into the casing through a respective aperture of the casing to provide a plurality of flow passages for gas passing through the casing, each flow passage extending between an inlet and an outlet of a respective cartridge, each cartridge housing means for condensing species from the gas passing therethrough as a condensate collecting within the cartridge.

The condensing means preferably comprises means for cooling the gas passing through the cartridge to a temperature at or below which a condensable species within the gas condenses into a condensate. For example, each cartridge may comprise a duct for conveying within the cartridge a flow of coolant for cooling the gas passing through the cartridge. The coolant preferably comprises a liquid coolant, preferably water, which may be refrigerated if desired. By providing a cold trap at the inlet of the pump, there is no requirement to heat the pump to prevent the condensation of the condensable species within the pump, and therefore there is no risk of promoting within the pump the conversion of other unreacted species of the gas stream to solid material.

In one embodiment, the condensing means comprises a plurality of cooling fins in thermal contact with the duct and arranged such that gas flowing through the cartridge passes over the cooling fins. In another embodiment, the duct is a helical duct, the flow passage comprising a first portion extending along and about the duct, and a second portion extending along the longitudinal axis of the duct. Each cartridge preferably comprises at least one baffle for directing gas entering the cartridge towards one of the first and second portions of the flow passage. The baffle is preferably in the form of a ring extending about the duct to separate the cartridge into first and second chambers. Gas enters the first chamber from the cartridge inlet, passes along the outside of the duct, and then changes direction at the end of the cartridge and passes along the inside of the helical duct into the second chamber, from which the gas leaves the cartridge through the outlet thereof. Due to the contact of the gas with both the internal and the external surfaces of the helical duct, the exposure of the gas to the cold surfaces of the helical duct can be maximised. To facilitate cleaning of the duct, a metallic sleeve may be placed over the outside of the duct so that the condensate forms on the outer surface of the sleeve rather than on the outer surface of the helical duct.

A secondary cooling coil may be fitted to the base of the casing to reduce the temperature of the gas stream entering the trap.

A different type of mechanism for removing species from the gas stream may be employed within the cartridges. For example, in another preferred embodiment each cartridge comprises means for heating gas passing through the cartridge to a temperature at or above which an unreacted species within the gas is converted into solid material. Thus, in a third aspect the present invention provides a trap device for removing species from a gas stream drawn from an enclosure by a vacuum pump, the device comprising a casing having an inlet for receiving the gas stream and an outlet for exhausting the gas stream from the casing, and a plurality of cartridges each being removably insertable into the casing through a respective aperture of the casing to provide a plurality of flow passages for gas passing through the casing, each flow passage extending between an inlet and an outlet of a respective cartridge, each cartridge housing means for heating the gas passing therethrough.

The heating means may conveniently comprise a heater and a plurality of fins arranged in thermal contact with the heater and such that gas flowing through the cartridge passes over the fins. For example, the heating means may comprise a duct housing the heater, the fins being mounted on the duct. This duct preferably extends along the length of the cartridge. The fins may be arranged in the form of baffles to define a tortuous flow passage for gas flowing though the cartridge, or in any other arrangement.

In yet another preferred embodiment, each cartridge comprises at least one filter element for removing particulates from the gas passing through the cartridge. Thus, in a fourth aspect the present invention provides a trap device for removing particulates from a gas stream drawn from an enclosure by a vacuum pump, the device comprising a casing having an inlet for receiving the gas stream and an outlet for exhausting the gas stream from the casing, and a plurality of cartridges each being removably insertable into the casing through a respective aperture of the casing to provide a plurality of flow passages for gas passing through the casing, each flow passage extending between an inlet and an outlet of a respective cartridge, each cartridge housing at least one filter element for removing particulates from the gas passing therethrough.

Said at least one filter element preferably defines a tortuous flow passage for a gas stream passing through the device. By arranging the filter element(s) to define a tortuous passage, for example, a spiral or sinusoidal passage, for a gas stream passing through the trap, the gas stream is forced to repeatedly change direction as it passes from the inlet towards the outlet of the casing. Each time the gas stream changes direction, particulates within the gas stream are thrown outwards from the gas stream and trapped by a filter element. The filter element(s) thus become progressively blocked from the inlet to the outlet of the cartridge. In the event that the filter element(s) become completely blocked, the gas stream is still able to flow through the cartridge to the outlet of the casing, albeit without any filtering of the particulates contained within, so that pumping performance is not lost.

Each cartridge may house a plurality of filter elements spaced along the longitudinal axis thereof and defining therebetween said flow passage.

To facilitate cleaning, at least part of the cartridge is preferably detachable to expose at least part of the removal means. For example, the body of the first chamber of the cartridge may be removable from the remainder of the cartridge to provide access to the removal means.

The casing preferably comprises at least one baffle for directing gas entering the casing from the inlet thereof into the cartridges. In the preferred embodiment, the baffle is in the form of a plate defining a plurality of openings each for receiving a respective cartridge. The plate preferably separates the casing into a first plenum chamber, which is in fluid communication with the inlet of the casing and the inlets of the cartridges, and a second plenum chamber, which is in fluid communication with the outlets of the cartridges and the outlet of the casing.

In a fifth aspect, the present invention provides a vacuum pumping arrangement comprising a vacuum pump having an inlet for receiving a gas stream and an outlet for exhausting a pumped gas stream, and a trap device as aforementioned having an outlet connected to the inlet of the vacuum pump.

To provide an indication of the blockage of one or more of the cartridges, means may be provided for monitoring a pressure differential across the trap device, and for generating an alert depending on the magnitude of the monitored pressure differential.

Due to the modular nature of the trap device, different cartridges may be inserted into the casing depending on the nature of the gas stream passing through the cartridge. For example, whilst for one gas stream it would be desirable to use cartridges housing filter elements for removing particulates from the gas stream, for another gas stream it would be more desirable to use cartridges housing means for condensing condensable species within the gas stream. The trap may therefore be supplied with a single casing and different sets of cartridges, each set having its own respective mechanism for removing species from the gas stream, so that the trap may be rapidly and easily customised to suit the gas stream passing therethrough.

Therefore, in a sixth aspect the present invention provides a kit of parts comprising a casing having an inlet for receiving a gas stream, an outlet for exhausting the gas stream from the casing and a plurality of apertures each for receiving a respective cartridge, and a plurality of sets of cartridges for removing species from the gas stream, each cartridge being removably insertable into the casing through a respective aperture of the casing and providing a respective flow passage between an inlet and an outlet thereof for gas passing through the casing, wherein each set of cartridges has a respective different mechanism for removing species from the gas stream as solid material collecting within the cartridge.

As opposed to providing a plurality of sets of cartridges, a plurality of different sets of mechanisms for removing species from the gas stream may be provided, each mechanism being provided as an insert removably insertable into a cartridge. Therefore, in a seventh aspect the present invention provides a kit of parts comprising a casing having an inlet for receiving a gas stream, an outlet for exhausting the gas stream from the casing and a plurality of apertures each for receiving a respective cartridge, a plurality of cartridges, each cartridge being removably insertable into the casing through a respective aperture of the casing and providing a respective flow passage between an inlet and an outlet thereof for gas passing through the casing, and a plurality of sets of inserts for the cartridges, each insert comprising means for removing species from the gas stream, wherein each set of inserts removes species from the gas stream by a respective different mechanism.

Features described above in relation to first to fourth aspects of the invention are equally applicable to the sixth and seventh aspects of the invention, and vice versa.

Preferred features of the present invention will now be described with reference to the accompanying drawing, in which

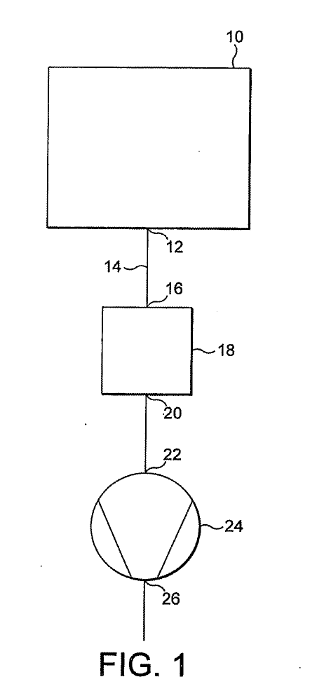

FIG. 1 illustrates schematically an example of a processing system;

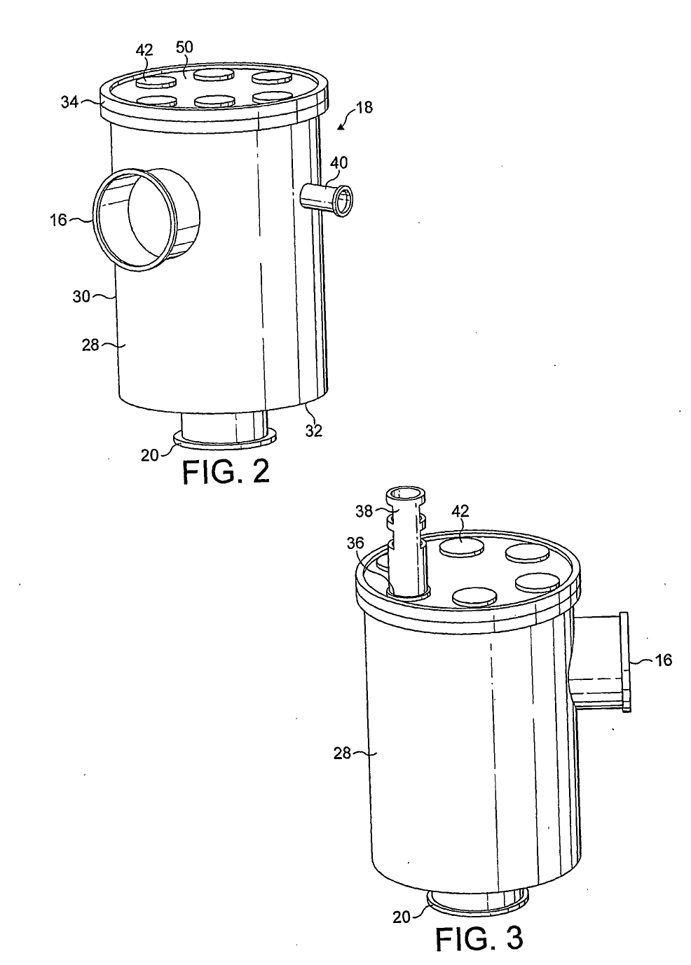

FIG. 2 is a perspective view of a trap device suitable for use in the system of FIG. 1;

FIG. 3 is a perspective view of the trap of FIG. 2, with one of the cartridges of the trap partially removed from the casing;

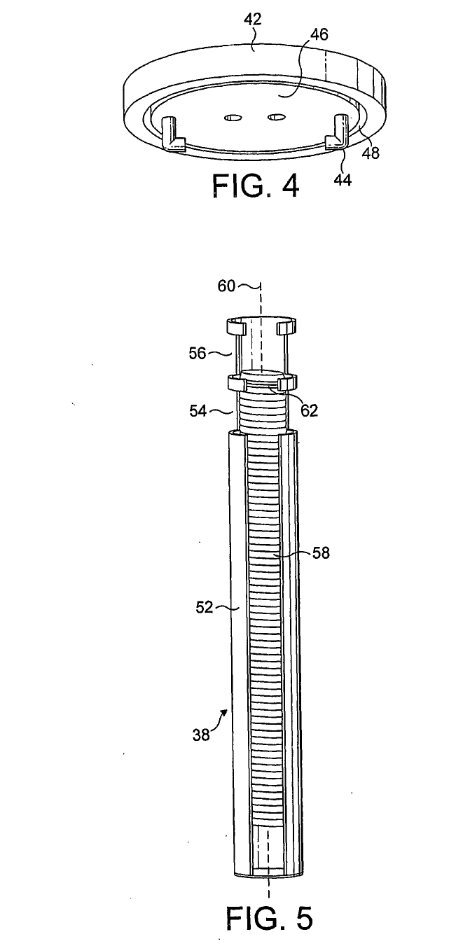

FIG. 4 is a perspective view of a lid of one of the cartridges of the trap of FIG. 2;

FIG. 5 is a perspective view of a first embodiment of a cartridge suitable for use in the trap of FIG. 2, with part of the casing removed to reveal the mechanism for removing species from a gas stream flowing through the cartridge;

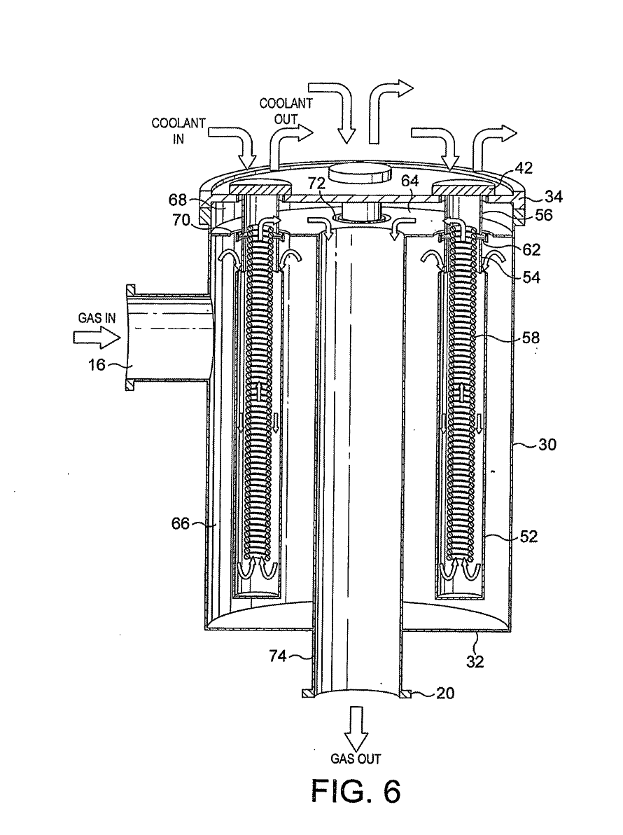

FIG. 6 is a cross-sectional view of the trap of FIGS. 2 and 3 incorporating a plurality of cartridges of FIG. 5;

FIG. 7 is a perspective view of a second embodiment of a cartridge suitable for use in the trap of FIG. 2, with part of the casing removed to reveal the mechanism for removing species from a gas stream flowing through the cartridge;

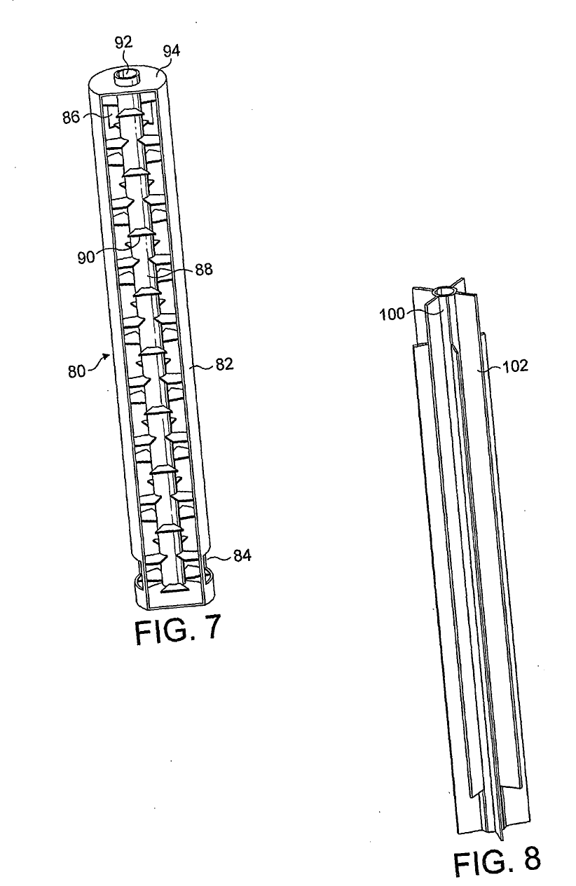

FIG. 8 is a perspective view of another mechanism for removing species from a gas stream flowing through the cartridge;

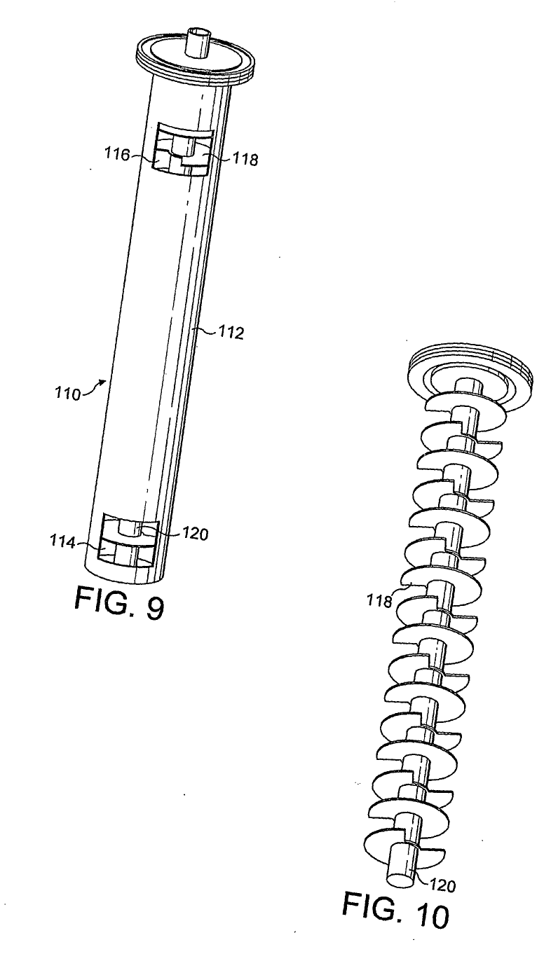

FIG. 9 is a perspective view of a third embodiment of a cartridge suitable for use in the trap of FIG. 2;

FIG. 10 is a perspective view of the trapping mechanism of the cartridge of FIG. 7; and

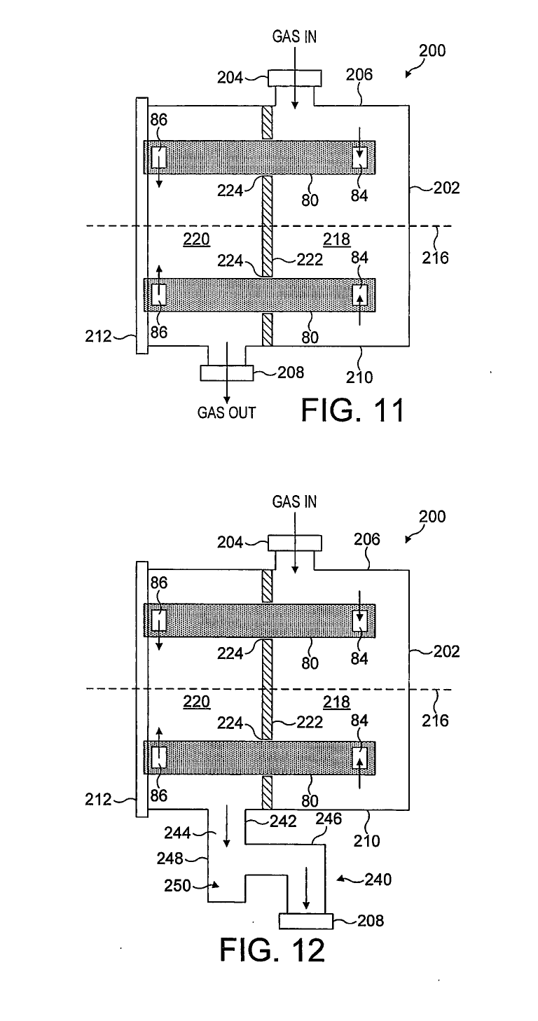

FIG. 11 is a schematic cross-sectional view of another trap device suitable for use in the system of FIG. 1;

FIG. 12 is a schematic cross-sectional view of a further trap device suitable for use in the system of FIG. 1; and

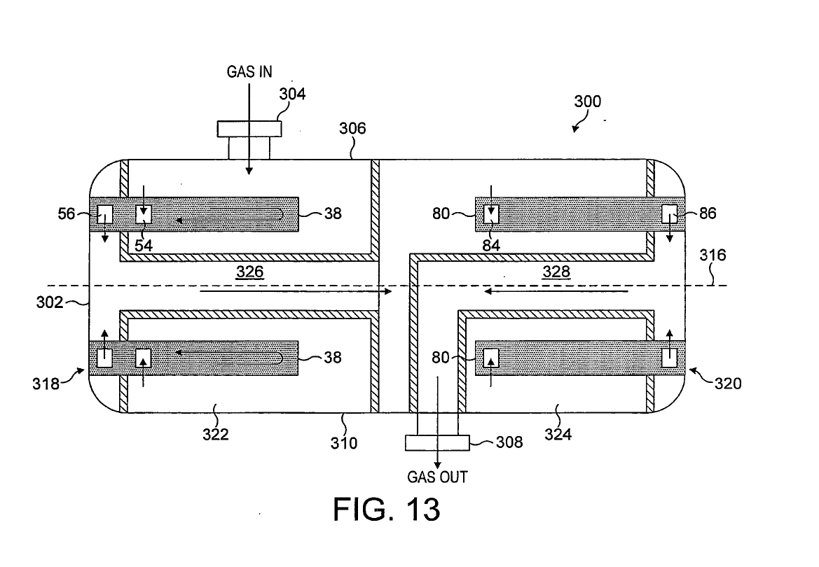

FIG. 13 is a schematic cross-sectional view of yet another trap device suitable for use in the system of FIG. 1.

With reference to FIG. 1, a processing system, for example for semiconductors or flat panel display devices, comprises a process chamber 10 having at least one inlet for receiving one or more process gases, and an outlet 12 for exhausting unconsumed process gases containing by-products from the process conducted within the process chamber 10. The outlet 12 from the process chamber 10 is connected by conduit 14 to the inlet 16 of a trap device 18 for removing species from the gas stream exhaust from the process chamber 10. The trap 18 has an outlet 20 connected to the inlet 22 of a vacuum pump 24 for drawing the gas stream from the process chamber 10. The vacuum pump 24 has an exhaust 26 connected to the inlet of a backing pump or to the inlet of a scrubbing device as required.

FIG. 2 is a perspective view of an example of the trap 18. The trap 18 comprises a cylindrical casing 28 having a flanged inlet 16 formed in a sidewall 30 of the casing 28 for connection to the conduit 14, and a flanged outlet 20 extending from an end wall 32 of the casing 28 for connection to the inlet 22 of the pump 24. The casing 28 has a lid 34 defining a plurality of apertures 36 each for receiving a respective cartridge 38 removably insertable into the casing 28, as shown in FIG. 3, for removing one or more species from a gas stream passing through the trap 18. In the illustrated embodiment, the lid 34 has six circular apertures 36 equidistantly spaced about the longitudinal axis of the casing 28. However, the number of apertures 36, the size of the apertures 36 and/or the shape of the apertures 36, and thus the number, size and/or shape of cartridges 38 insertable into the casing 28, can be altered depending on, for example, the size of the pump 24 and the gases that will be contained within the gas stream entering the trap 18. Returning to FIG. 2, the casing 28 also includes a port 40 formed in the sidewall 30 through which one or more of a purge gas, a thermocouple, a pressure gauge or other sensor, may be inserted into the casing 28.

Each cartridge 38 has a lid 42 by means of which the cartridge 38 is mounted in the casing 28. The lid is shown in more detail in FIG. 4. Each cartridge 38 is secured to a respective lid 42 by any suitable means, for example, a screw thread or, as illustrated, by means of resilient L-shaped fingers 44 provided on the lower (as shown) surface 46 of the lid 42 and which locate within one or more corresponding recesses or apertures provided in the cartridge 38. Each lid 42 has a diameter that is greater than that of the apertures 36 in the casing so that when a cartridge 38 is fully inserted into the casing, the cartridge 38 is suspended within the casing 28 by its lid 42. The lid 42 of the cartridge 38 can then be secured to the lid 34 of the casing 28 by any suitable means, such as clamps or the like. A groove 48 may be formed on the lower surface 46 of the lid 42 to receive an O-ring seal (not shown) to form a gas-tight seal with the upper (as shown) surface 50 of the lid 34 when the lid 42 is secured to the casing 28.

With reference now to FIG. 5, each cartridge 38 comprises an elongate cartridge casing or body 52 having at least one inlet 54 and at least one outlet 56. The body 52 houses a mechanism for removing species from a gas stream passing through the cartridge 38. In this embodiment, the body 52 houses a mechanism for cooling the gas stream to condense condensable species within the gas stream to form a solid condensate within the body 52 of the cartridge 38. This mechanism is provided by a helical duct 58 extending along the length of the cartridge 38 and about the longitudinal axis 60 of the cartridge 38. The ends of the helical duct 58 are connected to piping (not shown) extending through the lid 42 of the cartridge 38, for supplying to the helical duct 58 a coolant for cooling the internal and external surfaces of the helical duct 58. The cartridge 38 also includes a baffle 62 in the form of a ring located about the helical duct 58 and axially between the inlet 54 and the outlet 56 of the cartridge 38.

FIG. 6 illustrates a number of cartridges 38 inserted into the casing 28. The casing 28 includes a plate 64 arranged substantially orthogonal to the longitudinal axis of the casing 28 that internally divides the casing 28 into a first, annular plenum chamber 66 for receiving gas from the inlet 16 and a second plenum chamber 68 from which gas flows towards the outlet 20. The plate 64 includes a series of first apertures 70 which are arranged substantially co-axial with the apertures 36 in the lid 34 to receive the cartridges 38, and a second, central aperture 72 from which gas is exhaust from the second chamber 68. The inlet 54 of the cartridge 38 is positioned such that, when the cartridge 38 is fully inserted into the casing 28, the inlet 54 is in fluid communication with the first plenum chamber 66 only, and the outlet 56 of the cartridge 38 is positioned such that, when the cartridge 38 is fully inserted into the casing 28, the outlet 56 is in fluid communication with the second plenum chamber 68 only. Consequently, the cartridges 38 provide a plurality of individual flow passages for gas passing from the first plenum chamber 66 to the second plenum chamber 68.

As illustrated in FIG. 6, the flanged outlet 20 of the trap 18 is provided by one end of a cylindrical duct 74 extending centrally-through the first plenum chamber 66, the other end of the cylindrical duct 74 being attached to the plate 64 so to receive gas from the second aperture 72 of the plate 64.

In use, a gas stream enters the first plenum chamber 66 of the casing 28 from the inlet 16 and passes into the cartridges 38 through the inlets 54 thereof. Within each cartridge 38, the baffle 62 directs the gas entering the cartridge 38 downwards (as illustrated) between the external surface of the helical duct 58 and the interior surface of the body 52 of the cartridge 38. At the bottom of the cartridge 38, the gas changes direction and passes upwards (as illustrated) along the inside of the helical duct 58. As the gas is conveyed through the cartridge 38, it is cooled, in turn, by the cold external and internal surfaces of the helical duct 58. Condensable species within the gas are condensed from the gas stream as solid material forming on the surfaces of the helical duct 58. At the top of the cartridge 38, the gas is exhaust from the outlet 56 into the second plenum chamber 68. The gas stream then passes through the second aperture 72 into the cylindrical duct 74, which conveys the gas stream to the outlet 20 of the trap 18.

The replacement of one or more of the cartridges 38 of the trap 18 can be timed according to the processes taking place in the process chamber 10 so as not to disrupt the processing within the chamber. Alternatively, or additionally, means may be provided for monitoring a pressure drop across the trap, and when the pressure drop reaches a predetermined value indicative of a blocking of one or more of the cartridge 38, an alert may be generated to advise a user that cartridge replacement is required. When one of the cartridges 38 need replacing, it can be easily removed from the casing 28 by releasing the clamps hold the lid 42 of the cartridge 38 to the lid 34 of the casing 28, and lifting the cartridge 38 from the casing 28. As the solid condensate from the gas stream is retained within the body 52 of the cartridge 38, the user's exposure to this solid material is minimised. A fresh cartridge 38 can then be inserted into the casing 28. The replaced cartridge 38 can then be taken to a suitable place for cleaning of the helical duct 58 and/or replacement of the helical duct. Part of the body 52 of the cartridge 38 may be removable to provide user access to the internal and external surfaces of the helical duct 58.

Due to the modular nature of the trap 18, the trap 18 may be provided with different sets of cartridges 38, each set including a different respective mechanism for removing species from the gas stream. This can enable the trap 18 to be easily customised according to the nature of the gas stream drawn from the enclosure by the vacuum pump 24. FIGS. 7 to 10 illustrate some alternative cartridges and/or mechanisms for removing species from the gas stream passing through the trap.

Turning first to FIG. 7, the cartridge 80 comprises an elongate body 82 having at least one inlet 84 at one end thereof for receiving gas from the first plenum chamber 66 of the casing 28, and at least one outlet 86 at the other end thereof for exhausting gas from the cartridge 80 to the second plenum chamber 68 of the casing 28. This cartridge 80 includes a mechanism for heating the gas passing through the cartridge 80 to convert unreacted species in the gas stream, such as tungsten hexafluorate or copper precursors used in the CVD of a copper film on a substrate, into solid material. This mechanism comprises a heated duct 88 extending axially along the length of the cartridge 80, the duct 88 having a plurality of metallic fins 90 mounted thereon and substantially orthogonal thereto to provide heated baffles for heating the gas passing through the cartridge 80. The duct 88 may be heated by any suitable means, for example, by an electrical heater located within the duct 88. An aperture 92 located in the lid 94 of the cartridge 80 enables the heater to be connected to an external power source. In use, the elevated temperature within the cartridge 80 promotes the conversion of unreacted copper precursors into copper, which forms as a copper film over the duct 88 and fins 90.

FIG. 8 illustrates an alternative removal mechanism suitable for use within the cartridge 80 of FIG. 7. This mechanism comprises a duct 100 having a plurality of metal fins 102 extending radially therefrom. Similar to the embodiment of FIG. 7, the duct 100 can receive a heater for heating the fins 102 and thus the gas passing through the cartridge 80, or, similar to the helical duct 58 of the embodiment of FIG. 5, can receive a flow of coolant for cooling the fins 102 and thus the gas passing through the cartridge 80. As another alternative, each of the metal fins 102 may be replaced by a plurality of shorter metals fins spaced along the duct 100.

FIG. 9 illustrates schematically a cartridge 110 comprising an elongate body 112 having at least one inlet 114 at one end thereof and at least one outlet 116 at the other end thereof. This cartridge 110 includes a filter mechanism for capturing particulates contained in the gas stream passing through the cartridge 110. With reference to FIG. 10, in this example, the cartridge 110 comprises a plurality of filter elements 118 mounted on a shaft 120 extending along the length of the cartridge 110. The filter elements 118 may be formed from any suitable material, for example porous stainless steel. The filter elements 118 are shaped and mounted on the shaft 120 so as to define a tortuous flow passage between the opposing surfaces of adjacent filter elements 118 for the gas stream entering the cartridge 110. As the gas stream passes along the flow passage within the cartridge 110, it is forced to continually change direction by the filter elements 118 as it flows towards the outlet 116. Particulates within the gas stream are thrown outwardly from the gas stream as it changes direction, whereupon they become trapped by the filter elements 118 and unable to return to the gas stream. During use, the filter elements 118 will become increasingly blocked from the inlet 114 of the cartridge 110 to the outlet 116 of the cartridge 110. Even when the filter elements 118 has become fully blocked, the gas passage remains unrestricted, and so there is no loss of performance of the vacuum pump 24. The spacing between the filter elements 118 may be adjusted to vary the pitch and/or number of filter elements 118 within the cartridge 110 so as to vary the degree of filtering performed by the cartridge 110, and thus enable the cartridges 110 to be customised according to the nature of the process gas flows and the required service intervals. The fins 90 in the embodiment illustrated in FIG. 7 may be similarly adjusted.

The trap device 18 can therefore be provided with a plurality of sets of cartridges, each set housing a respective different mechanism for removing species from a gas stream. For example, the trap device 18 may be provided with four sets of cartridges, the sets comprising, in turn, a mechanism for cooling the gas stream, a mechanism for heating the gas stream, a relatively coarse set of filter elements and a relatively fine set of filter elements, respectively. For the trap device illustrated in FIG. 2, each set would comprise at least six cartridges but preferably more, for example at least twelve cartridges so as to provide at least six replacement cartridges that can be used whilst six other cartridges are being cleaned.

Returning to FIG. 2, the cartridges are vertically inserted into, and removed from, the trap device 18. FIG. 11 illustrates a trap device 200 in which cartridges are inserted horizontally into the trap device. The trap device 200 comprises a casing 202 having a flanged inlet 204 formed in a top (as illustrated) wall 206 of the casing 202 for connection to the conduit 14, and a flanged outlet 208 extending from a bottom wall 210 of the casing 302 for connection to the inlet 22 of the pump 24. The casing 202 has a removable lid 312 located in a sidewall thereof defining a plurality of apertures for receiving a set of cartridges removably insertable into the casing 202. In the illustrated embodiment, the lid 212 has six circular apertures equidistantly spaced about the longitudinal axis 216 of the casing 202 for receiving a set of cartridges. Each cartridge may be provided with a lid similar to the lid 42 shown in FIG. 4 for releasably securing the cartridge to the lid 212.

In the illustrated example, the set of cartridges comprises a plurality of cartridges 80 similar to those shown in FIG. 7 for heating the gas stream to remove unreacted species from the gas stream. Consequently, the respective mechanisms used in the cartridges 80 for removing species from the gas stream will not be described again in detail. Alternatively, any of the other cartridges described above with reference to FIGS. 5 to 10 may be used with the trap device 200.

The casing 202 is internally divided into two adjacent plenum chambers 218, 220 by a plate 222 arranged substantially orthogonal to the longitudinal axis 216 of the casing 202. The first plenum chamber 218 receives gas from the inlet 204 and the second plenum chamber 220 conveys gas flows towards the outlet 208. The plate 222 includes a series of apertures 224 which are arranged substantially co-axial with the apertures in the lid 212 to receive the cartridges 80. As with the trap device 18, when each cartridge 80 is fully inserted into the casing 202, the inlet 84 of the cartridge 80 is in fluid communication with the first plenum chamber 218 only, and the outlet 86 of the cartridge 80 is in fluid communication with the second plenum chamber 220 only. Consequently, the cartridges 80 provide a plurality of individual flow passages for gas passing from the first plenum chamber 218 to the second plenum chamber 220.

In use, a gas stream enters the first plenum chamber 218 from the inlet 204 and passes into the cartridges 80 through the inlets 84 thereof. As the gas is conveyed through the cartridges 80, it is heated by the hot baffles located therein, which can cause unreacted species to form deposits on the surfaces of the baffles. The gas is exhaust from the outlets 86 of the cartridges 80 into the second plenum chamber 220, which conveys the gas stream to the outlet 208 of the trap 200. Removal of the lid 212 can enable at least the second plenum chamber 220 to be periodically cleaned, if required, when one or more of the cartridges 80 are replaced as described above in connection with the trap device 18.

Depending on the nature of the gas stream output from the process chamber 10, it may be desirable to use two different trapping mechanisms for removing species from the gas stream. FIG. 12 illustrates a modification of the trap device 200 illustrated in FIG. 11, in which a conduit 240 extends between the bottom wall 210 of the casing 202 and the gas outlet 208. The conduit 240 comprises a first, downwardly extending conduit portion 242 that receives the gas stream from the second plenum chamber 200 and extends to a branch portion 244. At the branch portion 244, the first conduit portion 242 branches into a second conduit portion 246 extending outwardly from the first conduit portion 242 for conveying the gas stream from the first conduit portion 242 to the gas outlet 208, and a third, downwardly extending conduit portion 248 which terminates at a deadleg-style trap device 250. The deadleg trap 250 collects particulates or debris from incomplete reactions which is thrown from the gas stream as it changes direction as it passes from the first conduit portion 242 to the second conduit portion 246. A gate valve may be provided between the deadleg trap and the conduit 240 for selectively isolating the deadleg trap 250 from the gas stream, for example during emptying of the deadleg trap 250.

Alternatively, it may be desirable to use both relatively coarse and relatively fine filter elements to remove a range of differently sized particulates from the gas stream, or it may be desirable to use both a mechanism for condensing condensable species from the gas stream and a mechanism for heating the gas stream to remove unreacted species therefrom. FIG. 13 illustrates schematically an example of a trap device 300 which may interchangeably house any two different mechanisms for removing species from the gas stream. Similar to the trap device 18 illustrated in FIG. 2, the trap device 300 comprises a casing 302 having a flanged inlet 304 formed in a top (as illustrated) wall 306 of the casing 302 for connection to the conduit 14, and a flanged outlet 308 extending from a bottom wall 310 of the casing 302 for connection to the inlet 22 of the pump 24. The casing 302 has sidewalls 312, 314 each defining a plurality of apertures for receiving a respective set of cartridges removably insertable into the casing 302. In the illustrated embodiment, the sidewall 312 has six circular apertures equidistantly spaced about the longitudinal axis 316 of the casing 302 for receiving a first set of cartridges 318, and the sidewall 314 similarly has six circular apertures equidistantly spaced about the longitudinal axis 316 of the casing 302 for receiving a second set of cartridges 320. Each cartridge may be provided with a lid similar to the lid 42 shown in FIG. 4 for releasably securing the cartridge to a sidewall 312, 314.

In the illustrated example, the first set of cartridges 318 comprises a plurality of cartridges 38 similar to those shown in FIG. 5 for removing condensable species from the gas stream passing through the trap device 300, and the second set of cartridges 320 comprises a plurality of cartridges 80 similar to those shown in FIG. 7 for heating the gas stream to remove unreacted species from the gas stream. Consequently, the respective mechanisms used in the two sets of cartridges 318, 320 for removing species from the gas stream will not be described again in detail.

The casing 302 is internally divided into two substantially annular plenum chambers 322, 324. The first plenum chamber 322 is arranged to receive the gas stream from the inlet 304 of the trap device 300, and includes a series of first apertures which are arranged substantially co-axial with the apertures in the sidewall 312 to receive the cartridges 38 such that, when the cartridge 38 is fully inserted into the casing 302, only the inlet 54 is in fluid communication with the first plenum chamber 322. The second plenum chamber 324 is arranged to receive gas exhaust from the first set of cartridges 318, and includes a series of second apertures which are arranged substantially co-axial with the apertures in the sidewall 314 to receive the cartridges 80 such that, when the cartridge 80 is fully inserted into the casing 302, only the inlet 84 is in fluid communication with the second plenum chamber 324. The casing 302 includes porting 326 that conveys the gas exhaust from the first set of cartridges 318 to the second plenum chamber 324, and porting 328 that conveys the gas exhaust from the second set of cartridges 320 to the outlet 308.

In use, a gas stream enters the first plenum chamber 322 from the inlet 304 and passes into the cartridges 38 through the inlets 54 thereof. As the gas is conveyed through the cartridges 38, it is cooled, in turn, by the cold external and internal surfaces of the helical duct located therein so that condensable species within the gas are condensed from the gas stream as solid material forming on the surfaces of the helical duct. The gas is exhaust from the outlets 56 of the cartridges 38 into the porting 326, which conveys the gas stream to the second plenum chamber 324. The gas stream then passes into the cartridges 80 through the inlets 84 thereof. As the gas is conveyed through the cartridges 80, it is heated by the hot baffles located therein, which can cause unreacted species to form deposits on the surfaces of the baffles. The gas is exhaust from the outlets 86 of the cartridges 80 into the porting 328, which conveys the gas stream to the outlet 308 of the trap 300.

If the nature of the gas stream alters, then one or both of the two sets of cartridges may be replaced by a different set of cartridges. For example, the first set of cartridges may be replaced by a set of cartridges including filter elements, such as the cartridges 110 shown in FIG. 9, or by a further set of cartridges 80 for removing unreacted species from the gas stream. It may also be desirable to heat the gas stream to remove unreacted species before subsequently cooling the gas stream to remove condensable species, in which case the first and second sets of cartridges may be swapped over so that the gas stream passes through the heated cartridges 80 before passing through the cooled cartridges 38. Thus, where for example four different sets of cartridges are provided, each set comprising at least twelve cartridges, a user can be provided with sixteen different options for the arrangement of cartridges within the trap device 300.

1. A trap device for removing species from a gas stream drawn from an enclosure by a vacuum pump, the device comprising a casing having an inlet for receiving the gas stream and an outlet for exhausting the gas stream from the casing, and a plurality of cartridges each being removably insertable into the casing through a respective aperture of the casing to provide a plurality of flow passages for gas passing through the casing, each flow passage extending between an inlet and an outlet of a respective cartridge, each cartridge housing means for removing species from the gas passing therethrough as solid material collecting within the cartridge.

2. The trap device according to claim 1 wherein each removal means comprises means for condensing species from the gas passing through the cartridge as a condensate collecting within the cartridge.

3. A trap device for removing condensable species from a gas stream drawn from an enclosure by a vacuum pump, the device comprising a casing having an inlet for receiving the gas stream and an outlet for exhausting the gas stream from the casing, and a plurality of cartridges each being removably insertable into the casing through a respective aperture of the casing to provide a plurality of flow passages for gas passing through the casing, each flow passage extending between an inlet and an outlet of a respective cartridge, each cartridge housing means for condensing species from the gas passing therethrough as a condensate collecting within the cartridge.

4. The trap device according to claim 2 wherein the condensing means comprises cooling means for cooling the gas passing through the cartridge to a temperature at or below which a condensable species within the gas condenses into a condensate.

5. The trap device according to claim 2 wherein the condensing means comprises a duct for conveying within the cartridge a flow of coolant for cooling the gas passing through the cartridge.

6. The trap device according to claim 5 wherein the coolant comprises a liquid coolant, preferably water.

7. The trap device according to claim 5 wherein the condensing means comprises a plurality of cooling fins in thermal contact with the duct and arranged such that gas flowing through the cartridge passes over the cooling fins.

8. The trap device according to claim 5 wherein the condensing means comprises a helical duct, the flow passage comprising a first portion extending along and about the duct, and a second portion extending along the longitudinal axis of the duct.

9. The trap device according to claim 8 wherein each cartridge comprises baffle means for directing gas entering the cartridge towards one of the first and second portions of the flow passage.

10. The trap device according to claim 1 wherein each removal means comprises at least one filter element for removing particulates from the gas passing through the cartridge.

11. A trap device for removing particulates from a gas stream drawn from an enclosure by a vacuum pump, the device comprising a casing having an inlet for receiving the gas stream and an outlet for exhausting the gas stream from the casing, and a plurality of cartridges each being removably insertable into the casing through a respective aperture of the casing to provide a plurality of flow passages for gas passing through the casing, each flow passage extending between an inlet and an outlet of a respective cartridge, each cartridge housing at least one filter element for removing particulates from the gas passing therethrough.

12. The trap device according to claim 10 wherein said at least one filter element defines a tortuous flow passage for a gas stream passing through the device.

13. The trap device according to claim 12 wherein said at least one filter element defines a sinusoidal flow passage for the gas stream.

14. The trap device according to claim 10 wherein each cartridge houses a plurality of filter elements spaced along the longitudinal axis thereof and defining therebetween said flow passage.

15. The trap device according to claim 1 wherein each removal means comprises means for heating gas passing through the cartridge to a temperature at or above which an unreacted species within the gas is converted into solid material.

16. A trap device for removing species from a gas stream drawn from an enclosure by a vacuum pump, the device comprising a casing having an inlet for receiving the gas stream and an outlet for exhausting the gas stream from the casing, and a plurality of cartridges each being removably insertable into the casing through a respective aperture of the casing to provide a plurality of flow passages for gas passing through the casing, each flow passage extending between an inlet and an outlet of a respective cartridge, each cartridge housing means for heating the gas passing therethrough.

17. The trap device according to claim 16 wherein the heating means comprises a heater and a plurality of fins arranged in thermal contact with the heater and such that gas flowing through the cartridge passes over the fins.

18. The trap device according to claim 17 wherein the heating means comprises a duct housing the heater, the fins being mounted on the duct.

19. The trap device according to claim 18 wherein the duct extends along the length of the cartridge.

20. The trap device according to claim 18 wherein the fins are arranged to define a tortuous flow passage for gas flowing though the cartridge.

21. The trap device according to claim 16 wherein at least part of the cartridge is detachable.

22. The trap device according to claim 16 wherein the casing comprises baffle means for directing gas entering the casing from the inlet thereof into the cartridges.

23. The trap device according to claim 22 wherein the baffle means of the casing comprises a plate member defining a plurality of openings each for receiving a respective cartridge.

24. The trap device according to claim 22 wherein the inlet and the outlet of each cartridge are positioned such that, when the cartridge is fully inserted into the casing, the inlet and the outlet of the cartridge are located on opposite sides of the baffle means.

25. The trap device according to claim 22 wherein within the casing the baffle means separates a first plenum chamber, which is in fluid communication with the inlet of the casing and the inlets of the cartridges, from a second plenum chamber which is in fluid communication with the outlets of the cartridges and the outlet of the casing.

26. The trap device according to claim 16 wherein the casing is configured to receive at least three cartridges.

27. The trap device according to claim 16 wherein said plurality of cartridges are arranged about the longitudinal axis of the casing.

28. The trap device according to claim 27 wherein the cartridges are substantially equidistantly spaced about the longitudinal axis of the casing.

29. The trap device according to claim 16 wherein the inlet of the casing is located in a sidewall of the casing and the outlet of the casing is located in an end wall of the casing.

30. A vacuum pumping arrangement comprising a vacuum pump having an inlet for receiving a gas stream and an outlet for exhausting a pumped gas stream, and a trap device according to any preceding claim having an outlet connected to the inlet of the vacuum pump.

31. The vacuum pumping arrangement according to claim 30, comprising means for monitoring a pressure differential across the trap device, and for generating an alert depending on the magnitude of the monitored pressure differential.

32. A kit of parts comprising a casing having an inlet for receiving a gas stream, an outlet for exhausting the gas stream from the casing and a plurality of apertures each for receiving a respective cartridge, and a plurality of sets of cartridges for removing species from the gas stream, each cartridge being removably insertable into the casing through a respective aperture of the casing and providing a respective flow passage between an inlet and an outlet thereof for gas passing through the casing, wherein each set of cartridges has a respective different mechanism for removing species from the gas stream as solid material collecting within the cartridge.

33. A kit of parts comprising a casing having an inlet for receiving a gas stream, an outlet for exhausting the gas stream from the casing and a plurality of apertures each for receiving a respective cartridge, a plurality of cartridges, each cartridge being removably insertable into the casing through a respective aperture of the casing and providing a respective flow passage between an inlet and an outlet thereof for gas passing through the casing, and a plurality of sets of inserts for the cartridges, each insert comprising means for removing species from the gas stream, wherein each set of inserts removes species from the gas stream by a respective different mechanism.
